(19) United States
(12) Patent Application Publication
(10) Pub. No.: US 2002/0109843 A1
(43) Pub. Date: Aug. 15, 2002

(54) Method and system for registering fiducials employing backlighting techniques

(75) Inventors: Ali Ehsani, Tucson, AZ (US); Patrick McCarthy, Tucson, AZ (US); David R. Hill, Ora Valley, AZ (US)

Correspondence Address: PATENT COUNSEL, APPLIED MATERIALS, INC., Legal Affairs Department, P.O. Box 450A, Santa Clara, CA, 95052, US

(73) Assignee: Applied Materials, Inc.

(21) Appl. No.: 09/782,887

(22) Filed: Feb. 13, 2001

(51) Int. Cl. G01B 11/00

(52) U.S. Cl. 356/400

(57) ABSTRACT

A method and system to determine an alignment of a workpiece, with respect to a tool, by backlighting the workpiece. The workpiece includes fiducials, and the backlighting results in electromagnetic radiation passing through the fiducial. The electromagnetic energy emerging from the fiducial defines an emergent flux. A circumference of the emergent flux is ascertained, and the alignment is determined as a function of the circumference.

### BACKGROUND OF THE INVENTION

The present invention relates to patterns employed to register objects. More particularly, the present invention is directed toward a workpiece that employs fiducial marks to align the workpiece with a tool.

During various manufacturing processes, it is desired to align a workpiece that is the subject of a manufacturing operation with a tool, i.e., an instrument that will operate on the workpiece during the manufacturing operation. To that end, the workpiece typically includes fiducial marks that are sensed by a detector to ensure proper alignment between the workpiece and the tool. Historically, the detector consisted of a human eye viewing a reticle having a fixed position with respect to the tool. Proper alignment between the workpiece and the tool would be achieved by changing the relative position of the reticle and the fiducial marks until a desired spatial proximity between the two were obtained.

The drive to increase productivity has resulted in an alignment process, as well as many other manufacturing processes, becoming automated. As a result, many current alignment processes employ machine vision devices, examples of which include optical detectors such as a charged-coupled-device or a charge-injection-device. The tool and the optical detector are typically fixed to a mount that is coupled to a stage. The workpiece is disposed on the stage and the alignment process is regulated by computer control. Operating under computer control, either the stage, detector, or both, may move until the detector senses that a fiducial is in predefined alignment with the optical detector. The predefined alignment corresponds to a desired spatial relationship between the workpiece and the tool.

Before obtaining the predefined alignment, however, the fiducial must be sensed by the detector. To that end, a top-down illumination source may be employed to facilitate sensing of the fiducial by the detector. FIG. 1 shows a typical detection system that includes an optical detector 10 and a top-down illumination source 11. Illumination source 11 directs light along a light path 11a to illuminate a region 12 of a workpiece 13, where a fiducial 13a may be employed. Detector 10 has a field of view capable of sensing an area 14 of workpiece 13 that is smaller than region 12. This arrangement is referred to as top-down-bright-field illumination, because light reflected from region 12, and sensed by detector 10, travels along the same light path 11a as light generated by illumination source, but in an opposite direction. In other words, detector 10 senses light that is specularly from region 12.

Referring to FIG. 2, another example of top-down illumination is referred to as top-down-dark-field illumination. In this arrangement, illumination source 111 directs light along a path 111a to illuminate region 112 of workpiece 113. Detector 110, however does not sense specularly reflected light. Rather, detector 110 is orientated to sense light that reflects from region 112 and travels along a light path 111b that is not parallel to light path 111a. In this fashion, detector 110 senses light that is scattered from region 112.

Referring to FIG. 3, yet another example of a detection system as described in U.S. Pat. No. 4,463,673 to Moore employs backlighting techniques. The detection system is employed in a registration apparatus 15 that includes a workpiece holder assembly 16, a screen holder assembly 17, and a registration plate 19. Workpiece holder assembly 16 is provided with openings 16a for receiving lenses 20. Each lens 20 covers a source of light (not shown) and is transparent to the light produced thereby. A screen 18 is attached to screen holder assembly 17. Screen 18 is provided with a central region 18a having a pattern to be transferred to the workpiece (not shown), which may, for example, be a printed circuit board, integrated circuit, or the like. The region of screen 18 surrounding central region 18a is opaque to light and is provided with a pair of patterns 18b that have a cross-shaped configuration. The cross-shaped patterns are transparent to the light. Registration plate 19 is utilized to bring screen 18 into precise registry with the workpiece to be placed upon work holder assembly 16. To that end, registration plate 19 is provided with a pair of registration patterns 19a, each being defined by quadrant shaped openings 19b that define a cross-shaped region. Quadrant shaped openings 19b are transparent to light, and the cross-shaped region is opaque to the light. The cross-shaped region has a profile that matches the profile of transparent cross-shaped registration patterns 18b. During registration, patterns 19a are positioned adjacent to one of lenses 20 and registration patterns 18b are positioned adjacent to one of patterns 19a. Thus, the condition of precise registration is determined by viewing the superimposed members 16 and 19 and observing light passed by members 16 and 19. An absence of light indicates precise registration.

A drawback with the prior art detection systems is the inability to attenuate information associated with light reflected from anomalies proximate to the fiducials/registration patterns. As a result, the detection systems cannot determine proper alignment of the workpiece with respect to the tool.

What is needed, therefore, is a detection technique that overcomes the drawbacks associated with the prior art and enables proper alignment of the workpiece with respect to the tool.

### SUMMARY OF THE INVENTION

An embodiment of the present invention provides advantages to satisfy the aforementioned need with a method for determining an alignment of a workpiece with respect to a tool by passing electromagnetic energy through a fiducial associated with the workpiece, with electromagnetic energy emerging from the fiducial defining an emergent flux; ascertaining a circumference of the emergent flux; and determining the alignment as a function of the circumference. Another embodiment of the present invention includes a system that functions in accordance with this method to provide advantages to satisfy the aforementioned need.

### BRIEF DESCRIPTION OF THE DRAWINGS

FIG. 1 is a perspective view of fiducial detection system that employs top-down-bright-field illumination in accordance with the prior art;

FIG. 2 is a perspective view of fiducial detection system that employs top-down-dark-field illumination in accordance with the prior art;

FIG. 3 is an exploded perspective view of a prior art registration system employing backlighting techniques;

FIG. 4 is a perspective view of a laser pattern generator system fabricated in accordance with one embodiment of the present invention;

FIG. 5 is a plan view showing, in detail, the optical components of the laser pattern generator shown above in FIG. 4;

FIG. 6 is a detailed plan view of a workpiece, having photo-sensitive material and mylar thereon, disposed on a platen, shown above in FIG. 4;

FIG. 7 is a magnified top-down view showing a fiducial, discussed above with respect to FIG. 5, illuminated employing top-down-dark-field illumination;

FIG. 8 is a magnified top-down view showing a fiducial, discussed above with respect to FIG. 5, illuminated employing top-down-bright-field illumination;

FIG. 9 is a detailed plan view of the workpiece, shown above in FIG. 6, employing backlighting in accordance with one embodiment of the present invention;

FIG. 10 is a detailed plan view of the workpiece, shown above in FIG. 9, having photo-sensitive material and mylar on both sides thereof;

FIG. 11 is a top-down view of the platen shown above in FIG. 4;

FIG. 12 is a cross-sectional view of a platen, shown above in FIG. 11, in accordance with one embodiment of the present invention;

FIG. 13 is a cross-sectional view of a platen shown above in FIG. 11, in accordance with a first alternate embodiment of the present invention;

FIG. 14 is a cross-sectional view of a platen shown above in FIG. 11, in accordance with a second alternate embodiment of the present invention; and

FIG. 15 is a flow diagram showing a method of determining alignment of a workpiece, with respect to a tool, in accordance with one embodiment of the present invention.

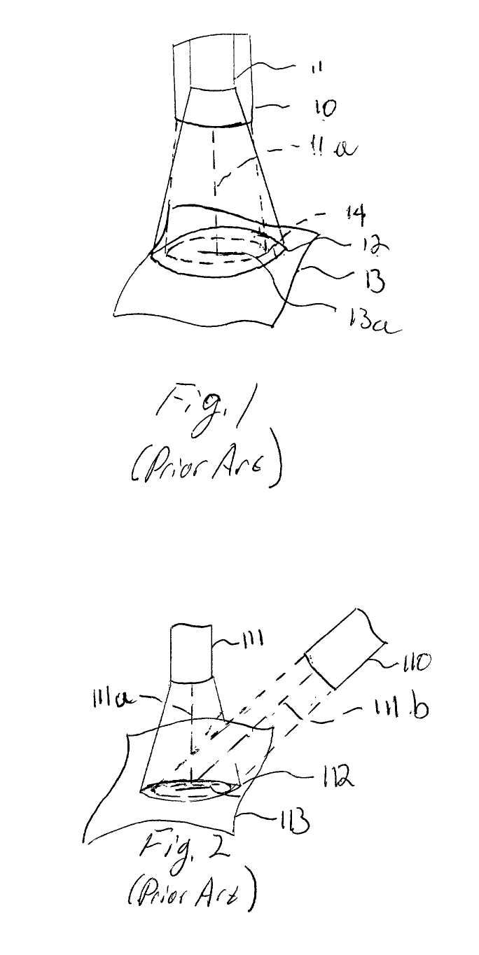

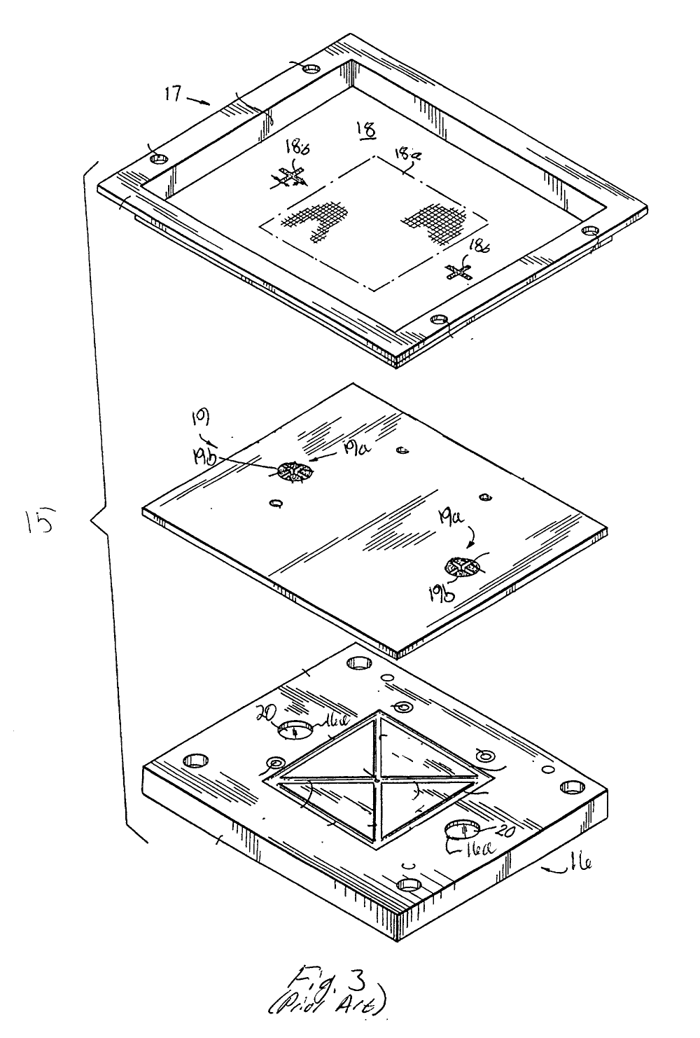

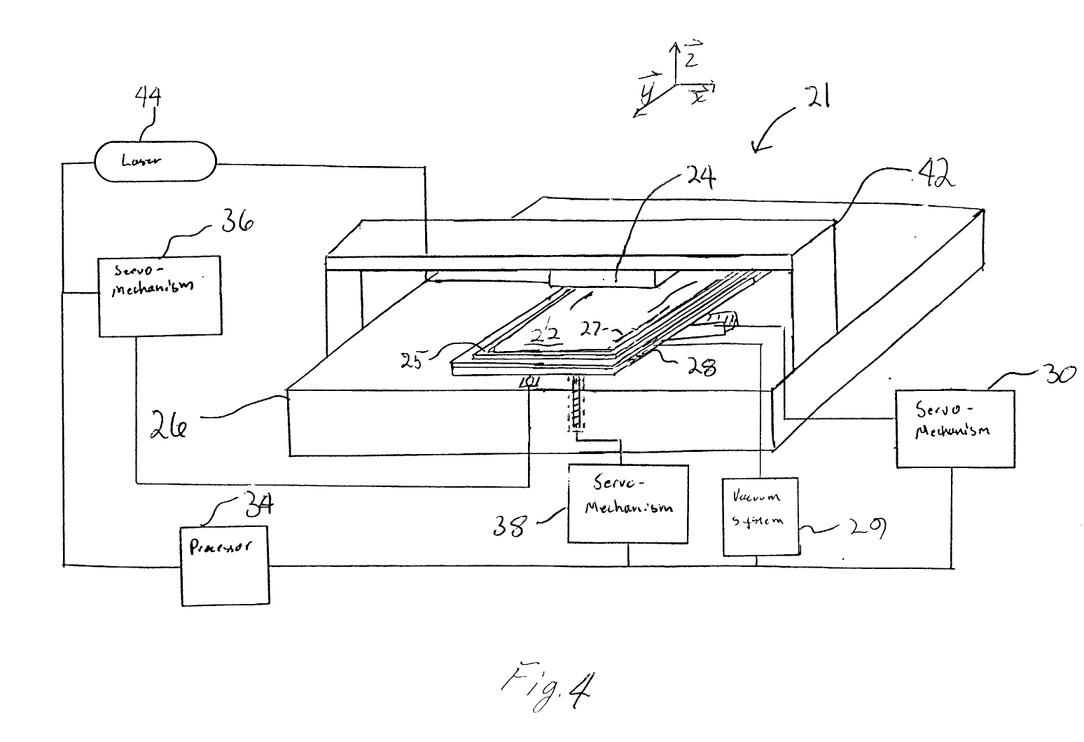

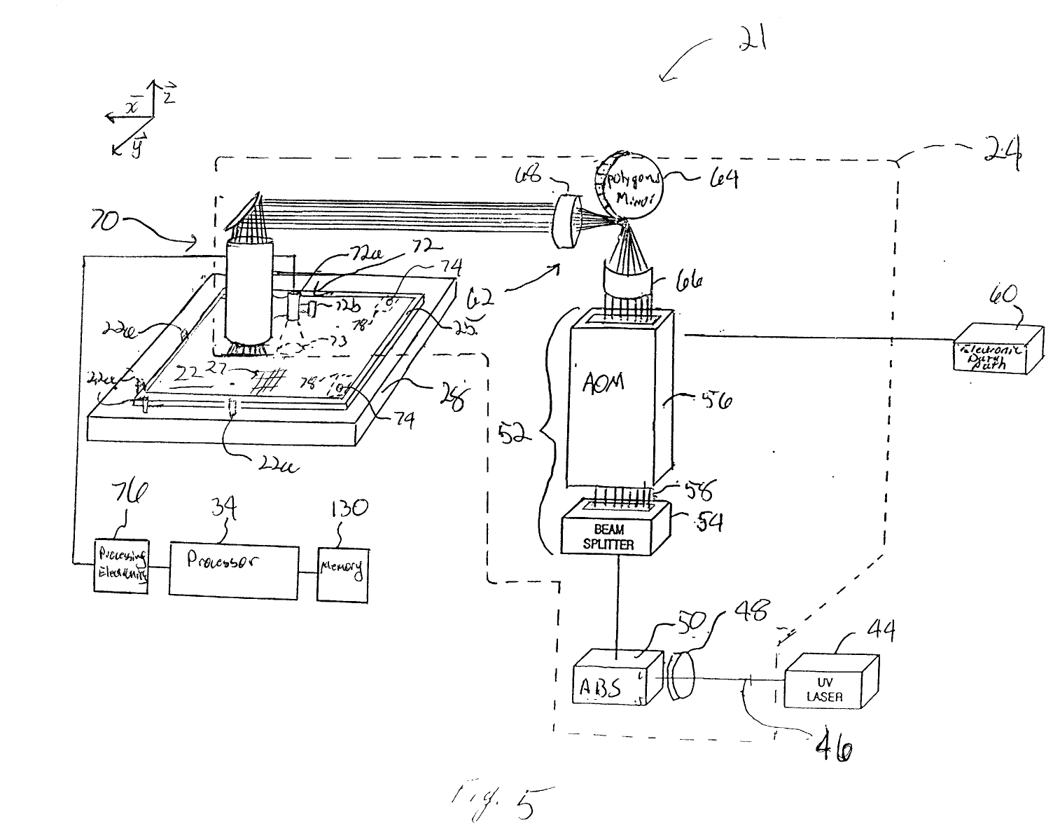

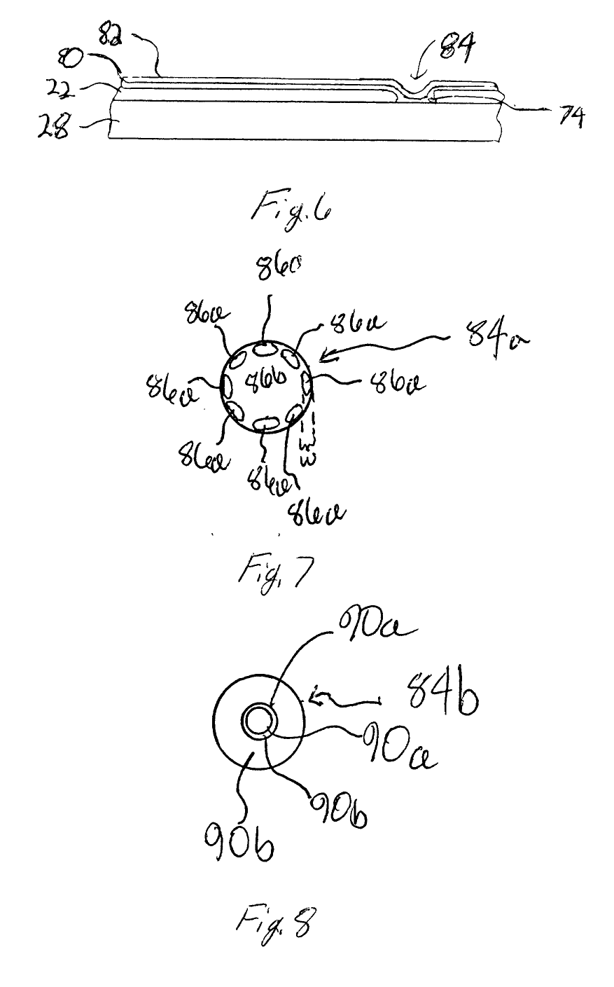

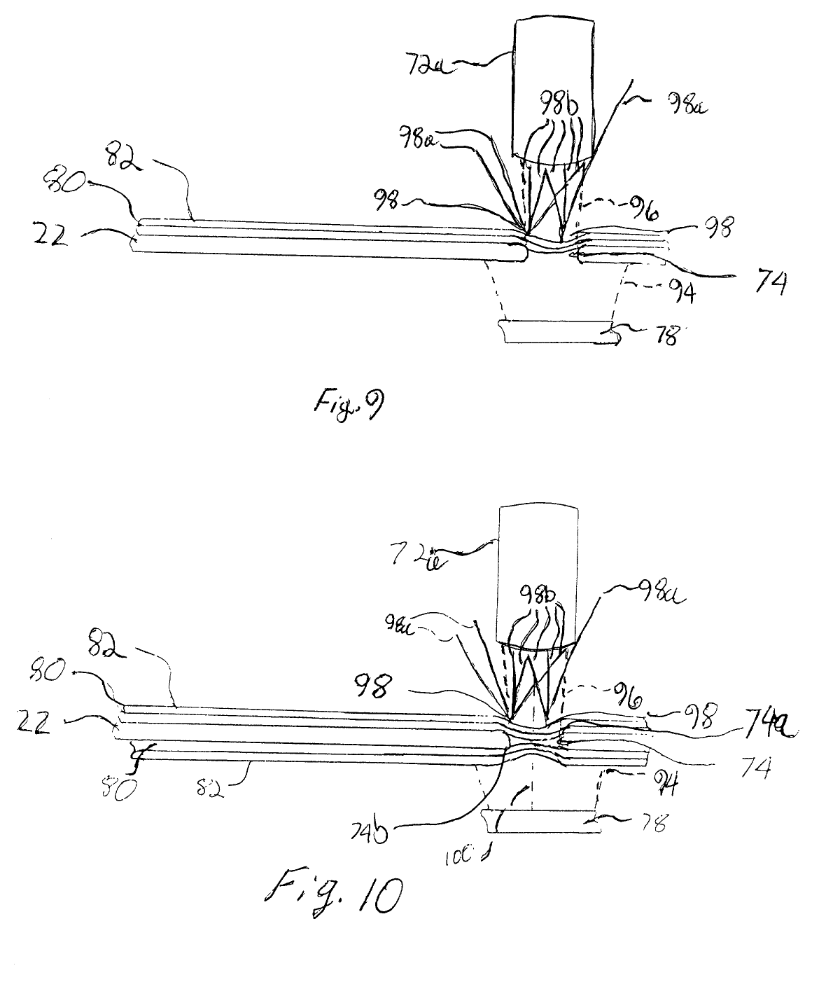

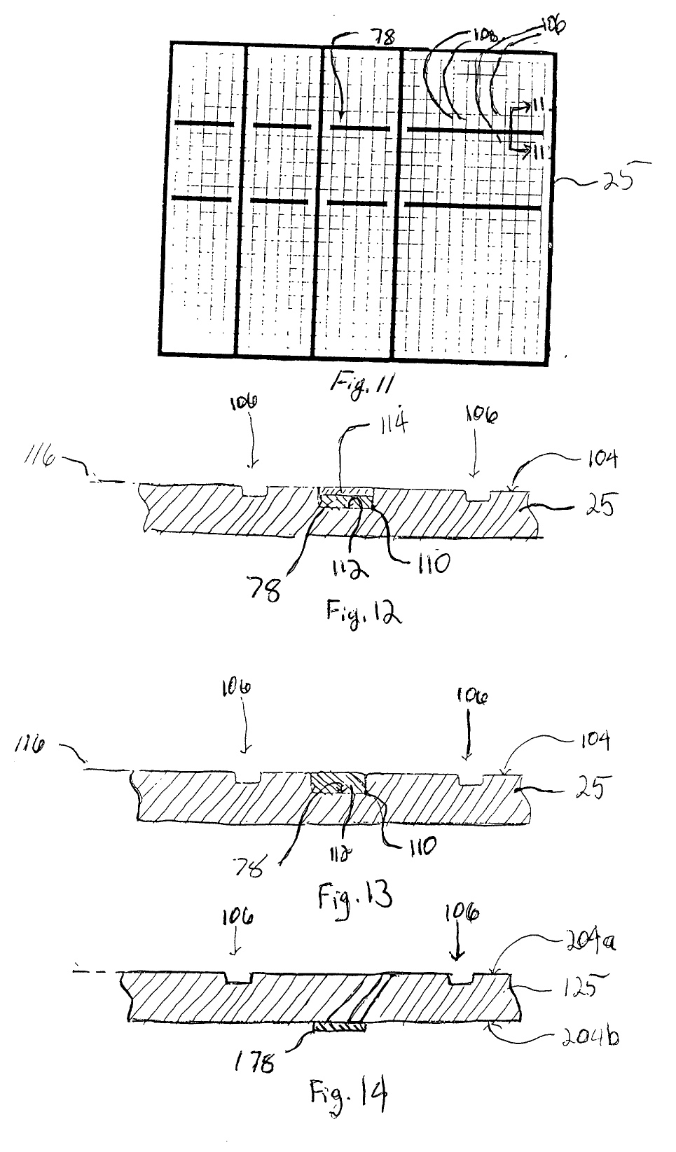

### DESCRIPTION OF THE SPECIFIC EMBODIMENTS

Referring to FIG. 4 a perspective view of a laser pattern generator system 21 fabricated in accordance with one embodiment of the present invention is shown. System 21 is suitable for generating patterns on a photosensitive layer, referred to as a workpiece 22, employing a beam source, referred to as a tool 24. To that end, system 21 includes a frame 26 to which a stage 28 is coupled. A platen 25 is disposed on stage 28, and workpiece 22 lies upon platen 25. Stage 28 is moveably attached to frame 26 to reciprocate in three directions, x, y and z, and rotate about the z direction. To that end, a first servo-mechanism 30, in data communication with a processor 34, is coupled to stage 28 to facilitate movement along the x direction. A second servo-mechanism 36, in data communication with processor 34, is coupled to stage 28 to facilitate movement in the y direction. A third servo mechanism 38, in data communication with processor 34, is coupled to stage 28 to facilitate movement in the z direction, as well as rotation about the z direction. Movement of stage 28 is achieved under control of processor 34. Platen 25 includes a plurality of vacuum grooves, one of which is shown as 27. Vacuum grooves 27 are in fluid communication with a vacuum system 29 and ensure that workpiece 22 is held flat against platen 25.

A boom 42 is coupled to frame 26 and extends parallel to the x direction. A laser 44 is in optical communication with tool 24. Under control of processor 34, laser 44 outputs a beam (not shown) that impinges upon workpiece 22 to form a pattern thereon. Movement between workpiece 22 and tool 24 is achieved by activating first and second servo-mechanisms 30 and 38 to translate stage 28 along the x and y directions, as discussed above. This allows the beam (not shown) to impinge upon any area of workpiece 24 as desired.

Referring to FIG. 5, laser 44 provides a radiant energy beam 46 for system 21 and is, for example, typically a five Watt, Argon-ion laser operating over a range of wavelengths of 351-385 nanometers. A pick-off mirror (not shown) directs beam 46 into a laser relay 48, causing beam 46 to impinge upon an automatic beam steering apparatus 50 (ABS). ABS apparatus 50 corrects for spatial drift in beam due, for example, to thermal fluctuations in laser 44, which ensures proper alignment of beam 46. This reduces the need to control the temperature of laser 44. This, in turn, reduces the need to perform manual alignment of beam 46. A multi-channel modulator 52 (MCM) is positioned after ABS 50. MCM 52 includes a beam splitter 54 and an Acousto-Optical Modulator 56 (AOM). Beam splitter 54 segments beam 46 into a plurality of beams, forming a beam brush 58. AOM 56 modulates the intensity of the beams associated with brush 58, as desired under control of a data path 60. To that end, data path 60 comprises a dedicated processor that operates on computer readable code to regulate the AOM operational parameters.

After exiting MCM 52, brush 58 passes through a scan lens system 62 that includes, for example, a rotating polygonal mirror 64, as well as pre-polygonal optics 66 and post-polygonal optics 68. Pre-polygonal optics 66 causes the beams of brush 58 to converge to a spot onto rotating polygonal mirror 64. Rotating polygon mirror 64 has a plurality of facets and causes brush 58 to scan workpiece 22 along a scan axis. One embodiment of the present invention employs a scan axis that extends parallel to the x direction and is approximately six inches in length. However, the scan axis may be of any length and any direction desired. For example, the scan axis may extend across the entire width of workpiece 22 along the x direction. In the present example, for a given pattern the rotating polygonal mirror rotates at a constant rate, but may be varied to match stage 28 velocity.

The beams reflected from polygonal mirror 64 then pass through post-polygonal optics 68 directing the same into relay 70. The beams exiting relay 70 scan workpiece 22. Specifically, to form an image on workpiece 22, workpiece 22 is scanned as stage 28 moves in the y direction, and the beam scans along the scan axis. This results in a plurality of scans, each of which is six inches in length. Each of the scans is displaced from an adjacent scan along the y direction. Thereafter, stage 28 moves in the x direction in preparation for another sequence of scans, each of which occurs in the scan axis, while stage 28 moves along y direction. This produces another set of a plurality of scans, displaced from the first set of scans in the x direction.

Referring to both FIGS. 4 and 5, an alignment system 72 facilitates aligning workpiece 22 with respect to tool 24. Alignment is determined as a function of a circumference of fiducials present on workpiece 22, which is described in greater detail below with respect to FIG. 15. Referring again to both FIGS. 4 and 5, two fiducials are shown as 74. To that end, alignment system 72 includes an optical detector 72a and a laser range finder 72b. In signal communication with both detector 72a and laser range finder 72b is processing electronics 76. Processing electronics 76 receives signals from either detector 72a or laser range finder 72b and produces signals that may be processed by processor 34, which is in data communication therewith. With this arrangement, proper alignment between workpiece 22 and tool 24 may be ensured, thereby facilitating precisely registering an image, written by tool 24, with respect to workpiece 22.

Alignment system 72 cooperates with an illumination source, shown by dashed lines 78, to overcome a problem concerning reflection of electromagnetic radiation. Referring to FIG. 6, a problem was found in that light was reflected from fiducials 74 that hinders calculation of an accurate circumference of the same and, therefore, aligning workpiece 22 with tool 24.

Before a pattern is imaged on workpiece 22, a photo-sensitive layer 80 is disposed thereon. Also a layer of mylar 82 may be disposed on workpiece 22 to facilitate patterning of photo-sensitive layer 80. A portion of photo-sensitive layer 80 and mylar 82 often covers one or more of fiducials 74, creating what is referred to as a tented fiducial 84. As a result, electromagnetic radiation impinging thereon creates artifacts that are sensed by detector 72a, when employing standard illumination techniques.

Referring to FIGS. 5, 6 and 7, were top-down-dark-field illumination employed, a pattern 84a sensed by detector 72a includes artifacts 86 that are reflections from the uneven surface of tented fiducial 84. Artifacts 86a are bright regions, with surrounding regions 86b of pattern 84a being dark. As a result, determining the circumference of fiducial 74 is greatly hindered. Artifacts 86a define optical contrasting regions that hinder accurate determination of a fiducial circumference, because the width, w, of each of artifacts 86a may define a circumference that may vary ±w. Thus, the circumference may be out of tolerance, resulting in fiducial 84 not being identified.

Referring to FIGS. 5 and 8, an analogous problem exists were top-down-bright-field illumination employed. A pattern 84b sensed by detector 72a employing top-down-bright-field illumination includes artifacts that are characterized as bright concentric rings 90a. Regions 90b surrounding rings 90a are dark. Determining the accurate circumference of pattern 84b is hindered by the difficulty in determining which of the rings define the circumference thereof.

To overcome this drawback, the present invention employs backlighting of fiducials 74 with sufficient electromagnetic flux impinging upon detector 72a to ensure any artifacts present in fiducials 74 are not sensed. As shown in FIG. 9, illumination source 78 emits electromagnetic radiation 94 in the form of light that impinges upon fiducials 74. A sub-portion of radiation 94 passes through fiducials 74, and emerges therefrom as an emergent flux 96. Detector 72a senses the irradiance (watts/m²) of emergent flux 96 impinging thereupon and produces signals in response thereto that include information corresponding to one of fiducials 74. Processor 34 identifies the edge of emergent flux 96 by finding optically contrasting regions sensed by detector 72a. A boundary, typically annular in shape, is fitted to the shape of the edge identified by processor 34.

Referring to FIG. 9, artifacts produced by radiation 94 may be characterized as points 98 of dispersive radiation shown as rays 98a and 98b. The total power associated with rays 98a and 98b defines a radiant flux (watts). A sub-portion of the radiant flux, i.e., rays 98b, falls within the detection area of detector 72a, referred to as dispersive rays, while the remaining portion of the radiant flux, i.e., rays 98a, falls outside of the detection area, referred to as scattered rays. Thus, a component of emergent flux 96 includes dispersive rays 98b and, therefore, information corresponding to the artifacts. The power per unit area of dispersive rays 98b impinging upon detector 72a defines an irradiance. The remaining component of emergent flux 96 comprises the undispersed radiation, which includes information corresponding to fiducial 74. The power per unit area of the undispersed radiation defines an irradiance. However, radiation 94 is provided with sufficient power to ensure that the irradiance associated with the undispersed radiation is greater than the irradiance associated with dispersive rays 98b. Specifically, the relative irradiance between the undispersed radiation and dispersive rays 98b is such that the total irradiance sensed by detector 72a is substantially uniform across the detection area. In this manner, information corresponding to artifacts is attenuated and the irradiance sensed by detector 72a corresponds to electromagnetic radiation with substantially all the information contained therein corresponding to fiducial 74.

Referring to FIG. 10, an additional benefit provided by the present invention is that problems regarding misalignment of the features of fiducial 74 may be overcome. Specifically, as shown, often both sides of workpiece 22 are patterned, i.e., photo-sensitive material 80 and mylar 82 may be disposed on both sides. This requires proper alignment with respect to a common fiducial to ensure that the pattern on one side of the workpiece is registered properly with respect to the pattern on the opposing side. To that end, fiducial 74 is usually formed as a throughway extending between opposing sides of workpiece 22. The opposed ends of fiducial 74 terminate in an orifice, shown as 74a and 74b. However, fiducial 74 is formed by drilling or punching through workpiece 22. The drilling process often does not produce a perfectly cylindrical fiducial. As a result, orifices 74a and 74b disposed on opposing ends of fiducial 74 may not be centered on a common axis, shown as 100. Were top-down illumination employed, the circumference of the fiducial sensed by detector 72a, which is defined, for example, by orifice 74a, would be offset with respect to the circumference of fiducial 74, defined by orifice 74b. This situation hinders properly aligning the pattern on one side of workpiece 22 with respect to a pattern on the opposing side. The magnitude and position of the circumference of fiducial 74 is dependent of the side of workpiece 22 facing detector 72a.

Employing backlighting in accordance with the present invention overcomes the problems associated with fiducial 74 feature misalignment, because fiducial 74 functions as an aperture stop for radiation 94. As a result, the smallest cross-section presented by fiducial 74 to radiation 94 traversing axis 100 defines the circumference of emergent flux 96 and, therefore, fiducial 74. In this fashion, the circumference of emergent flux 96 is independent of the side of workpiece 22 facing detector 72a.

Referring to FIGS. 11 and 12, to facilitate backlighting, platen 25 includes one or more illumination sources 78. As discussed above, a surface 104 of platen 25 includes a plurality of vacuum grooves 106 and 108 formed therein. A first subgroup 106 of the plurality of vacuum grooves extends along a first direction, and a second subgroup of the plurality of vacuum grooves 108 extends along a second direction, transversely to the first direction. Although any illumination source 78 may be employed, it is desired to provide an illumination source 78 that emits a wavelength of electromagnetic radiation to which photo-sensitive layer 80 will not be responsive. In one application, illumination source 78 comprises of electroluminescent material that emits wavelengths of electromagnetic radiation in the range of 410-620 nm. This range of wavelengths is desired, because photo-sensitive material 80 is typically material selected to be responsive to ultraviolet wavelengths.

Referring to both FIGS. 9 and 12, illumination source 78 is disposed in a recess 110 formed into surface 104. Recess 110 has a nadir 112. A body of glass 114 is disposed within recess 110, with illumination source 78 being disposed between body 114 and nadir 112. Body of glass 114 has sufficient thickness to ensure that the surface thereof, disposed opposite to illumination source 78, lies in a common plane, shown as 116, with surface 104. In this manner, the surface of platen 25 to which workpiece 22 is exposed is planar, which ensures that illumination source 78 is positioned as close to fiducial 74 as possible. This provides a maximum radiance of electromagnetic radiation propagating through fiducial 74. It should be understood however, that the need for body of glass 114 may be abrogated by providing illumination source 78 with sufficient thickness so as to extend from nadir surface 112 to common plane 116, shown in FIG. 13.

Referring again to both FIGS. 9 and 12, to relax the requirement of proximity between illumination source 78 and fiducial 74, body of glass 114 may be in the form of a projection lens. Alternatively, or in addition to, the projection lens, diodes emitting, for example, infra-red or near infra-red radiation, may be employed as illumination source 78. Also, semiconductor laser diodes may be employed. In this manner, collimated light may be provided which will abrogate the need for the projection lens or to place workpiece 22 in close proximity to illumination source 78.

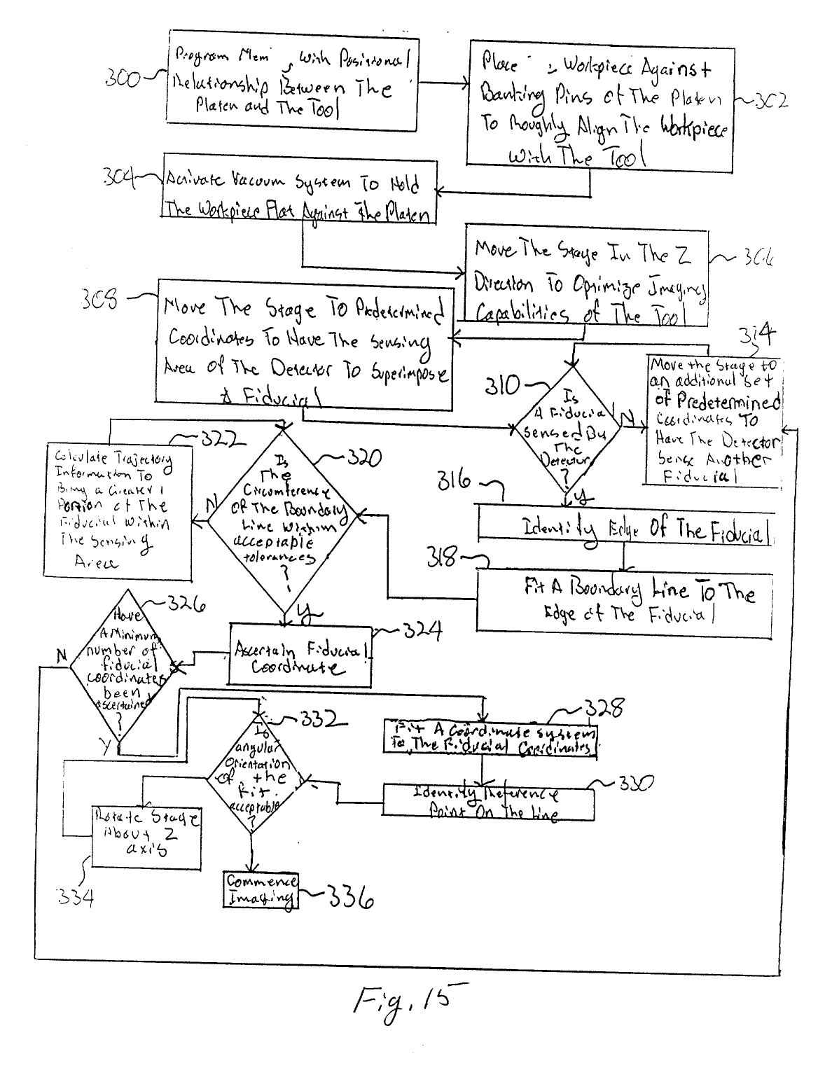

Referring to FIG. 14, platen 125 may be formed from a body of glass having opposed surfaces 204a and 204b surfaces, with illumination source 178 being disposed adjacent to surface 204b. Surface 204a includes the plurality of vacuum grooves 106 formed therein. In this manner, vacuum grooves 106 are disposed between illumination source 178 and the detector (not shown).

Referring to both FIGS. 5 and 15, to align workpiece 22 and tool 24, the position between tool 24 and platen 25 is programmed into a memory 130 that is in data communication with processor 34 at step 300. Rough alignment between workpiece 22 and tool 24 is then achieved by placing the workpiece 22 against banking pins 22a at step 302. Specifically, banking pins 22a place workpiece 22 into a predefined positional relationship with platen 25, thereby providing course alignment between workpiece 22 and tool 24. At step 304, vacuum system 29 is activated to form a vacuum in vacuum grooves 27 to hold workpiece 22 flat against platen 25. Employing laser range finder 72b, stage 28 is moved in the z direction to optimize the imaging capabilities of tool 24, which coincides with the optimal focus for detector 72a, referred to as leveling workpiece 22, at step 306. This is achieved by analyzing three regions of workpiece 22. The regions are selected to define a triangle, were a line drawn therebetween. The regions are selected so that the triangle has a maximum area allowed while being completely encompassed by the area of workpiece 22. The triangle is associated with a plane in which workpiece 22 is to be disposed. Then processor 34 directs servo-mechanism 38 to move stage 28 in the z direction so that workpiece 22 lies in the aforementioned plane.

After leveling workpiece 22, stage 28 is moved to predetermined coordinates, programmed into memory 130, to superimpose a sensing area 73 of detector 72a with a fiducial at step 308. After reaching the predetermined coordinates, processor 34 operates on the signal generated by detector 72a in response to light sensed in sensing area 73. Specifically, electromagnetic radiation, such as light, created by illumination source 78 passes through fiducial 74 and detector 72a senses a flux of the light emerging from fiducial 74. Processor 34 ascertains whether a sufficient amount of light is present to indicate the presence of fiducial 74 within sensing area 73 at step 310. If no light is sensed, then stage 28 is moved to an additional set of predetermined coordinates where an additional fiducial is expected to be located at step 314. At least two fiducials must be sensed by detector 72a to align workpiece 22 and tool 24 properly.

If sufficient light is sensed within sensing area 73 to indicate that a fiducial is present, processor 34 calculates the circumference of fiducial 74. Specifically, processor 34 identifies the edge of fiducial 74 as a function of the optically contrasting regions sensed by detector 72a, at step 316. After the edge of fiducial 74 is identified, processor 34 fits a boundary line thereto, at step 318. The circumference of the boundary line is determined and analyzed to determine whether it is within acceptable tolerances, at step 320. For purposes of the present invention, circumference encompasses any shape or contour of boundary line that encompasses a region. This may include, but is not limited to, circular boundaries, polygonal boundaries, elliptical boundaries, asymmetric boundaries and the like.

Were the circumference found not be within acceptable tolerances, e.g., indicating that the entire fiducial 74 is not within sensing area 73, processor 34 could calculate trajectory information to move stage 28 in the appropriate x-y direction to bring the entire fiducial 74 within sensing area 73, at step 322. Were the circumference found to be within acceptable tolerances, then fiducial 74 is considered to be registered properly, and a fiducial coordinate is ascertained, such as a centroid of the region encompassed by the boundary line, at step 324. At step 326, it is determined whether two fiducial coordinates have been ascertained, if not, steps 310, 314, 316, 318, 320, 322 and 324 are repeated. Once two or more fiducial coordinates are ascertained, a coordinate system is fitted thereto, at step 328. This coordinate system may be, for example, a line extending between two fiducial coordinates. A reference point lying along the line is determined, which in this example, could be the center of the line extending between two fiducial coordinates, at step 330. The orientation of the line is analyzed to determine whether it is acceptable at step 332 and, if necessary, servo-mechanism 38 is activated to rotate stage 28 to orientate the line as desired at step 334. Otherwise, imaging is commenced at step 336, because workpiece 22 is aligned properly with tool 24. In this fashion, the alignment between workpiece 22 and tool 24 may be determined and controlled, thereby facilitating proper registration of a pattern image on workpiece 22.

It should be understood that other arrangements that may be employed that would fall within the scope of the present invention. For example, the present invention may be employed along with top-down-dark-field illumination or top-down-bright-field illumination or both. Additionally, an x-ray source may be employed in place of the illumination source. In this arrangement, the detector would be capable of sensing x-rays. Also, the fiducial registration may be accomplished by other method than circumference calculation. For example, a centroid of the fiducial may be determined based on the area of fiducial or pattern recognition. Therefore, the scope of the invention should not be based upon the foregoing description. Rather, the scope of the invention should be determined based upon the claims recited herein, including the full scope of equivalents thereof.

What is claimed is:

1. A method for determining an alignment of a workpiece with respect to a tool, said workpiece of the type having a fiducial, said method comprising:
passing electromagnetic energy through said fiducial, with electromagnetic energy emerging from said fiducial defining an emergent flux;
ascertaining a circumference said emergent flux; and
determining said alignment as a function of said circumference.

2. The method as recited in claim 1 wherein ascertaining said circumference further includes sensing, with a detector, an irradiance associated with said circumference, and determining said alignment further includes determining said alignment as a function of said irradiance.

3. The method as recited in claim 1 wherein said electromagnetic radiation passing through said fiducial produces artifacts having a radiant flux that includes information associated with said artifacts, with a first component of said emergent flux comprising of a sub-portion of said radiant flux and the remaining components of said emergent flux having information corresponding to said fiducial and further including attenuating information in said emergent flux associated with said artifacts.

4. The method as recited in claim 1 wherein said electromagnetic radiation passing through said fiducial produces artifacts having a radiant flux that includes information associated with said artifacts, with a first component of said emergent flux comprising of a sub-portion of said radiant flux and the remaining components of said emergent flux having information corresponding to said fiducial, with ascertaining said circumference further including attenuating information associated with said artifacts by sensing, with a detector, an irradiance associated with said emergent flux that is substantially uniform over an area of said detector.

5. The method as recited in claim 1 wherein said electromagnetic radiation passing through said fiducial produces artifacts having a radiant flux associated therewith, with a first component of said emergent flux comprising of a sub-portion of said radiant flux, wherein ascertaining said circumference includes sensing, with a detector having a detection area associated therewith, a first irradiance associated with said first component and a second irradiance associated with the remaining components of said emergent flux, said first and second irradiance defining a combined irradiance that is substantially uniform over said detection area.

6. The method as recited in claim 5 wherein determining said alignment further includes determining said alignment as a function of said combined irradiance.

7. The method as recited in claim 1 wherein said fiducial extends between opposed sides of said workpiece and has a cross-sectional area associated therewith which defines an aperture stop, with passing electromagnetic radiation further including defining said circumference with said aperture stop.

8. The method as recited in claim 1 wherein said electromagnetic radiation is in the range of 410 to 620 nm.

9. The method as recited in claim 1 wherein passing electromagnetic radiation further includes generating said electromagnetic radiation from an electroluminescent source.

10. A system for determining an alignment of a workpiece with respect to a tool, said workpiece of the type having a fiducial, said system comprising:
means for passing electromagnetic energy through said fiducial, with electromagnetic energy emerging from said fiducial defining an emergent flux;
means for ascertaining a circumference of said emergent flux; and
means for determining said position as a function of said circumference.

11. A system for determining an alignment of a workpiece with respect to a tool, said workpiece of the type having a fiducial, said system comprising:
a displacement mechanism including a platen;
an illumination subsystem coupled to said platen, said illumination system including an illumination source disposed to propagate electromagnetic radiation through said fiducial, with electromagnetic energy emerging from said fiducial defining an emergent flux; and
a detection subsystem in optical communication with said workpiece to detect said emergent flux.

12. The system as recited in claim 11 wherein said illumination source includes a plurality of strips of electromagnetic material extending along said platen, with a first subset of said plurality of strips extending along a first direction and a second subset of said plurality of strips extending along a second direction, transverse to said first direction.

13. The system as recited in claim 12 wherein said platen includes a surface with a plurality of vacuum grooves formed therein, with a first subgroup of said plurality of vacuum grooves extending along said a first direction and a second subgroup of said plurality of vacuum grooves extending along said second direction, with strips associated with said first subset being disposed between adjacent vacuum grooves associated with said first subgroup and strips associated with said second subset being disposed between adjacent vacuum grooves associated with said second subgroup.

14. The system as recited in claim 11 wherein said platen includes a surface, lying in a plane, with a recess form into said surface, with said illumination source being disposed within said recess and further including an optically transmissive body, having opposed sides, disposed in said recess with one of said opposed sides resting against said illumination source, with the remaining side lying in said plane.

15. The system as recited in claim 11 wherein said illumination source includes a strip of electroluminescent material having opposed sides and said platen includes a surface, lying in a plane, with a recess form into said surface and having a nadir, with said strip being disposed in said recess with one of said opposed sides resting against said nadir, with the remaining side lying in a plane in which said surface lies.

16. The system as recited in claim 11 wherein said platen is formed from a body of glass having first and second opposed surfaces, with said illumination source being disposed adjacent to said first surface, with said second surface having a plurality of vacuum grooves formed therein and disposed between said first surface and said detection system.

17. The system as recited in claim 16 wherein said first opposed surface has an area associated therewith, with said illumination source consisting essentially of electroluminescent material completely covering said area.

18. The system as recited in claim 11 wherein said illumination source is from a group of consisting essentially of electroluminescent material, light emitting diodes and laser emitters.

19. The system as recited in claim 14 wherein said body comprises a projection lens.

20. The system as recited in claim 11 further including a top-down-dark-field illumination system in optical communication with said platen.

21. The system as recited in claim 11 further including a top-down-bright-field illumination system in optical communication with said platen.

22. A system for determining an alignment of a workpiece with respect to a tool, said workpiece of the type having a fiducial, said system comprising:
an illumination subsystem in optical communication with said workpiece;
a detection subsystem in optical communication with said workpiece, with said workpiece being disposed between said detector and said illumination system, said fiducial extending between opposed sides of said workpiece; and
a displacement mechanism including a platen, with said illumination system being coupled to said platen and including electroluminescent material disposed so that said fiducial superimposes a sub-portion of said electroluminescent material, with said detection system being in optical communication with said displacement system.

23. The system as recited in claim 22 wherein said electroluminescent material includes a plurality of strips extending along said platen, with a first subset of said plurality of strips extending along a first direction and a second subset of said plurality of strips extending along a second direction, transverse to said first direction.

24. The system as recited in claim 23 wherein said platen includes a surface with a plurality of vacuum grooves formed therein, with a first subgroup of said plurality of vacuum grooves extending along said first direction and a second subgroup of said plurality of vacuum grooves extending along said second direction, with strips associated with said first subset being disposed between adjacent vacuum grooves associated with said first subgroup and strips associated with said second subset being disposed between adjacent vacuum grooves associated with said second subgroup.

25. The system as recited in claim 24 wherein said surface, lies in a plane, and includes a plurality of recesses, each of which includes one of said plurality of strips, and further including a plurality of bodies of glass, each of which has opposed sides and is disposed in one of said plurality of recesses with one of said opposed sides resting against said electroluminescent material and the remaining side lying in said plane.

26. The system as recited in claim 25 further including a memory and a processor, said processor being in data communication with said illumination, detection and displacement systems and said memory, with said memory having a computer-readable program embodied therein, said computer-readable program including a first set of instructions to control the illumination system to pass said electromagnetic energy through said fiducial, and a second set of instruction to control said detection system to ascertain a circumference of said emergent flux, and a third set of instructions operated on by said processor to determine said alignment as a function of said circumference.

27. The system as recited in claim 26 wherein said second set of instructions further includes a first subroutine operated on by said processor to sense an irradiance associated with said circumference with a detector, and said third set of instructions further includes a second subroutine to determine said alignment further includes determining said alignment as a function of said irradiance.
